(19) United States
(12) Patent Application Publication
(10) Pub. No.: US 2024/0075328 A1
(43) Pub. Date: Mar. 7, 2024

(54) AUTOMATIC COOLING AND FIRE-EXTINGUISHING SYSTEM

(71) Applicant: ASES GROUP, s.r.o., Praha 4, Krc (CZ)

(72) Inventor: Tomáš Kantor, Roznov pod Radhostem (CZ)

(73) Assignee: ASES GROUP, s.r.o., Praha 4, Krc (CZ)

(21) Appl. No.: 17/268,460

(22) PCT Filed: Aug. 16, 2019
(86) PCT No.: PCT/CZ2019/000039

§ 371 Date: Oct. 6, 2022

(30) Foreign Application Priority Data
Aug. 29, 2018 (CZ) PV 2018-438

(51) Int. Cl. A62C 35/10

(52) U.S. Cl. CPC A62C 35/10

(57) ABSTRACT

The automatic cooling and fire-extinguishing system is designed to be arranged inside the protected equipment, is comprised of the medium vehicle made of polymeric material in the shape of a three-dimensional body, where the vehicle includes the pressurized confined medium and the vehicle is adjusted to spontaneously form a nozzle allowing the medium release, wherein the medium (2) is designed as cooling medium with fire-extinguishing effects; in addition, the system is equipped with a sensor(s) (4) to monitor and evaluate the thermodynamic state of the medium (2) inside the vehicle (1) or on its surface or to release the medium (2) from the vehicle (1) having a general shape, and to perform active intervention against the source of an undesirable change in temperature occurring inside the protected equipment. In addition, the system is fitted with a detector(s) (5) for the monitoring, evaluation, and control of thermal processes inside the protected equipment with the possibility of feedback-based adjustments allowing the protected equipment to be disconnected from the power supply unit, thus minimizing any negative thermal effect that starts developing inside the protected equipment or the possibility of secondary ignition occurrence.

### FIELD OF INVENTION

The invention concerns a system that monitors and suppresses undesirable thermal effects in engineering and technological equipment, hereinafter referred to as protected equipment, which is capable of the suppression of fires possibly originating inside such protected equipments.

### BACKGROUND OF THE INVENTION

Undesirable thermal effects can appear in many items of protected equipment. The negative impact of such effects can result in a progressive loss of functionality or destruction of the equipment concerned, and in extreme cases, a fire can break out. A plurality of processes, such as undesirable chemical reactions, electric short-circuits, system overheating, electric arc development, self-ignition of service fluids, etc. can be behind the aforementioned consequences.

The state of the art offers, on the one hand, a variety of solutions that cool down the protected equipment depending on its temperature by ventilation systems (i.e. prevention), and, on the other hand, solutions that are designed exclusively for the suppression of a fire that already broke out (i.e. suppression).

Among the known solutions are fire-suppression items belonging to the category of self-extinguishing systems providing fire protection of spaces, in particular of drive units of motor vehicles, electrical control panels, kitchen appliances, etc.

With the known self-extinguishing systems having a plurality of designs, pressurized extinguishing agent is confined in a closed vessel, hose, etc. due to a fire or increased temperature, the tightness of such a vessel, hose, etc. fails and the extinguishing agent is released to eliminate the fire. Alternatively, extinguishing agent is distributed to the risk area of the protected equipment by an integrated system of nozzles.

The U.S. Pat. No. 5,040,610 patent publication discloses a solution that includes a vessel made of polymeric material with a lockable opening for priming extinguishing agent and a valve for vessel pressurizing. If the vessel is exposed to the effect of flame or increased temperature, its integrity in a predefined place fails and the released medium suppresses the fire. In this case the fire-suppression item is equipped with a cover that can have a variety of shapes and can be used in rooms of buildings.

Among other known solutions is one comprised of a closed hose at least partly flexible, made of polyamide, the both ends of which are closed by fixed pressed-on plugs. The hose is filled up with pressurised extinguishing agent. The hose can be fitted with a mechanical pressure gauge of extinguishing agent to provide a visual check of its presence. As a result of a fire when the temperature around the hose exceeds 120° C., the tightness of the hose fails, the extinguishing agent is released and the fire suppressed. The used extinguishing agent has no side effects on the extinguished space or living organisms.

However, the known self-extinguishing systems report certain disadvantages and limitations concerning their use for fire protection. With the self-extinguishing items in the shape of a hose with fixed pressed-on plugs, the tightness of the hose cannot be guaranteed as the hose may be distorted during the plug pressing-on process with potential uncontrollable release of extinguishing agent. In addition, these items become effective only after the temperature in the place, where the item is arranged to eliminate fire, exceeds 120° C. when the fire may have caused extensive damage and may have spread in an uncontrollable way.

Another limitation present in the known self-extinguishing items in the shape of a hose rests in the minimum length being 400 mm, where the item with such a length is not able to protect in particular small spaces inside electrical control panels and technological equipment for which also the value of such items' diameter, being 18 mm, exceeds the value of spatial limits for protected equipment.

The composition of extinguishing agent used in the state-of-the-art items with the shape of a hose is intended for fire suppression in confined or semi-confined spaces, and in the case of initiation by heat exceeding 120° C. or by fire, the extinguishing agent is released from the hose via a nozzle formed by the mutual thermodynamic action of the hose and the extinguishing agent. During this process, thermal properties of the hose change and the extinguishing agent pressure increases, which leads to the hose distortion in the place of its highest burden and to a spontaneous formation of a nozzle from which the extinguishing agent is released into the protected space in a very short time and the fire is extinguished. This process is irreversible as once the extinguishing agent is released, the self-extinguishing item becomes non-functional and needs to be replaced. Until the item is replaced, the protected equipment is not safeguarded by this system against repeated self-ignition or another fire and not even the operator or control systems have any information as to the system initiation or failure due to its damage.

The state-of-the-art self-extinguishing systems are designed exclusively to fire suppression with drawbacks described above. In addition, there are solutions with auxiliary items, such as systems that include extinguishing agent distribution systems. Such distribution systems comprise pre-installed arranged nozzles and the extinguishing agent is released from a tank, usually a pressure vessel by a valve that can be controlled by electric signal sent out by fire detector. On the other hand, this means that such systems must be permanently connected to the electrical power unit and are characterized by different reaction times.

### SUMMARY OF THE INVENTION

The aforementioned disadvantages of the state of the art are eliminated by the automatic cooling and fire-extinguishing system, hereinafter referred to as the ACFES system, which has been designed to be arranged inside protected equipment and which is comprised of a three-dimensional polymeric vehicle that includes pressurized medium. The vehicle of the medium is adapted to required tightness failure under specified conditions. The nature of the ACFES system rests in the fact that a suitable combination of a general-shaped three-dimensional polymeric vehicle and a medium mixture composition has lead to the invention of a system utilizing the cooling effect of the medium while the medium keeps its extinguishing effects in case of thermal distortion, which immediately grows into a fire. The used medium is based on chemical extinguishing agents characterised in that their temperature upon release from the vehicle is negative, i.e. below 0° C., under the reference freezing point.

The medium with the aforementioned properties is hereinafter referred to as the medium. The general-shaped three-dimensional polymeric vehicle is hereinafter referred to as the vehicle. Below, a description of the ACFES system principle for the monitoring, evaluation and management of thermal process inside the protected equipment is provided. The ACFES system includes a sensor/sensors for the monitoring and evaluation of the thermodynamic state of the medium. In a preferred embodiment, a pressure sensor is employed. The pressure sensor(s) are positioned either directly in the medium (an internal sensor), or in direct contact with the vehicle (an external sensor). The ACFES system is also connected to the detector(s) for the monitoring, evaluation, and control of thermal processes inside the protected equipment.

An increased temperature in the monitored space of the protected equipment will induce an increased medium pressure that is detected. The sensor output can be used for direct elimination of the temperature increase causes. Alternatively, it can be processed in the form of a signal in the electronic fire alarm and detection systems or control units.

An increased temperature induces a change in physical parameters of the vehicle and medium, when in the critical phase the vehicle's integrity fails in the place with the maximum thermal load and the space of the protected equipment exposed to the risk is cooled down, or possibly extinguished by the medium released from the emergency nozzle spontaneously formed in the medium vehicle.

Directing the intervention towards the place with the maximum thermal load allows the maximum effect to be attained while minimizing the consequences of the negative thermal effect that started to develop.

Based on the preferred selection of materials for the vehicle and medium in combination with their spatial arrangement and setting of initial thermodynamic circumstances, the initiation temperature, at which the process inside the protected equipment subject to monitoring is regarded as critical and at which the formation of the emergency nozzle for the medium release is desirable, is modelled. Thanks to the aforementioned prerequisites the ACFES system can be effective from 30° C. Protected equipment in different applications have different critical values of temperature for which suitable parameters of the ACFES system are modelled based on a combination of the aforementioned parameters.

Within the framework of the monitoring, evaluation, and control of thermally sensitive processes inside equipment protected against negative thermal effects, a medium based on chemical extinguishing agents characterised in that their temperature upon release from the vehicle is negative, i.e. below 0° C., under the reference freezing point, is used. Utilization of this cooling feature while preserving the fire-extinguishing capacity of the medium, additional increase in temperature is eliminated, thus providing time required for the resolution of the critical situation. The released medium is neither harmful to human health, nor affecting the functionality of the protected equipment.

Possible arrangement of several ACFES systems with different initiation temperatures will allow a multiple-stage reaction, i.e. a repeated cooling or repeated fire-extinguishing intervention. Possible arrangement of a plurality of ACFES systems consolidates the effect and reliability of the protected equipment space safeguarding.

Consequently, the aforementioned application of the ACFES system can minimize any far-reaching damage to property or damage to health or even life that would be sustained otherwise. As far as individual functionalities of the ACFES system are concerned, several levels can be referred to in the case of combinations and applications mentioned above—starting with the least complicated arrangement providing a simple one-time fire-suppression action with accompanying indication or intervention in the protected equipment, up to the arrangement allowing cascaded repeated actions and active interventions. In specific applications of the ACFES system, the feedback-based control of the medium thermodynamic states by an initiation optimization element depending on changes in parameters of the ambient environment—initiation temperature control, is employed.

Thanks to the variability of its dimensions, the ACFES system designed according to the invention is broadly applicable to the safeguarding of protected equipment against thermal destruction or fire, namely starting from more bulky equipment up to very confined spaces, such as electrical installations boxes, cable bundle connectors, electrical control panels, confined spaces of drive units, fuel supply systems, etc. The ACFES system is designed to eliminate any undesirable leaks of the medium, its effects are very reliable and can also be used for live protected equipment or for equipment deployed in other hazardous environments. Even in the case of power supply failure or loss of power supply for the protected equipment, the ACFES system remains functional at least as an emergency passive fire-extinguishing system. The system can be initiated at lower temperatures compared to the known extinguishing systems, which allows earlier intervention and damage elimination at the very beginning of the system thermal destruction.

In the case of simple applications, the ACFES system is defined in the passive system mode. With more complicated arrangements, such as the implementation of feedback elements depending on the ambient environment parameters, etc., the ACFES system is defined in the active system mode.

Passive mode of fire-extinguishing—in this case, the ACFES system is designed for the suppression of a fire that has broken out very quickly and thermal distortion of the protected equipment could not be eliminated by only the cooling function of the system. In the case of the passive system variant, it is advisable to use a pressure sensor designed as a pressure switch that allows the operator or a parent system to be notified of the ACFES system initiation or inoperability and the required intervention, such as additional fire-extinguishing, replacement of the spent or damaged ACFES system element, etc.

In addition, the active method of solution also includes the monitoring of the protected equipment ambient environment state, evaluation of its current parameters that may affect the ACFES system efficiency, and where necessary, it optimises the course of initiation, such as by earlier initiation of the ACFES system compared to the settings of the ACFES system thermodynamic parameters, namely using a supplementary element affecting thermodynamic circumstances in the ACFES system in favour of the required initiation.

The active system also allows earlier warning of the occurrence of undesirable thermal effects, which helps prevent system overheating, spreading of distortion and destruction effects, eliminate a fire by early warning of the operator or by disconnecting the protected equipment subject to monitoring from the power supply units, or by preventing any secondary undesirable effect.

In another preferred embodiment the ACFES system is integrated in the systems disconnecting the protected equipment from the power supply unit or the ACFES system sensor(s) are part of a high-performance semiconductor device.

In yet another preferred embodiment, the vehicle is in mechanical contact with the external sensor serving as an element disconnecting the power supply unit from the protected equipment in the case of thermodynamic changes in the medium and vehicle.

In another preferred embodiment, the ACFES system is connected in systems designed for the protected equipment control.

In another preferred embodiment, the ACFES system is connected in the fire alarm and detection systems for the protected equipment.

In another preferred embodiment, the transfer of signals between the ACFES system and the control system or fire alarm and detection system for the protected equipment is wireless.

The ACFES system vehicle is also designed without openings and the integrity of the vehicle is attained by sealing, welding or gluing, or possibly with one or a plurality of openings equipped with plugs. In a preferred embodiment, the plugs closing the openings are made of polymeric material and are glued onto or welded into the vehicle, thus eliminating leaking in the place of connection. One plug of the vehicle is fitted with a sensor of the ACFES system thermodynamic state, which is thus in direct contact with the medium—the internal sensor.

No minimum spatial dimensions for the vehicle arrangement are specified; where the vehicle has the shape of a hose, neither its diameter nor length is specified; where necessary, the minimum length of the hose starts at 10 mm and the inner diameter at 3 mm.

In yet another preferred embodiment, the ACFES system with the vehicle in the shape of a hose or a different general shape made of transparent material, includes an element allowing the visual indication of medium presence that is situated in the medium and has its specific density lower than the medium specific density, for example a lightweight colour bead inside the vehicle.

### BRIEF DESCRIPTION OF THE DRAWINGS

The invention is further explained in the attached drawings, where

FIG. 1 shows a flow diagram of the principle of monitoring and suppression of undesirable thermal effects in the protected equipment,

FIG. 2 shows a schematic drawing of the section of the ACFES system in the shape of a hose,

FIGS. 3a and 3b show schematic drawings of the ACFES system to be employed in electrical control panels,

FIG. 4 shows a schematic drawing of the section of the ACFES system for the protection of breakers and sockets in the shape of a capsule,

FIG. 5 shows a schematic drawing of the section of the ACFES system for the protection of cable bundle connectors in the shape of a cartridge, and

FIG. 6 shows a schematic drawing of the section of the ACFES system key element for the protection of battery systems.

### EXAMPLE(S) OF THE INVENTION EMBODIMENT

FIG. 1 is a schematic drawing of the principle of the ACFES system function for the control of thermal process inside the protected equipment subject to monitoring. The vehicle 1 includes the medium 2 with cooling and fire-extinguishing effects. The medium 2 is confined in the vehicle 1 in pressurized form. In the vehicle 1, the nozzle 3 created by thermodynamic effect for the medium 2 release into the space of the protected equipment is shown. The ACFES system is fitted with the internal sensor(s) 4a or external sensor(s) 4b or with both of them for the monitoring and evaluation of the thermodynamic state of the medium 2 with changing temperature and the medium 2 release indication. In a preferred embodiment this ACFES system is interconnected to the detector(s) 5 for the monitoring, evaluation, and control of thermal processes within the space of the protected equipment.

The sensors output is used for direct elimination of the temperature increase causes or is further processed in the form of a signal in the electronic fire alarm and detection systems or control units. In specific applications of the ACFES system, the feedback-based control of the medium 2 thermodynamic states is utilised, by processing signals from the sensors 4 and detectors 5, as provided in the schematic diagram in FIG. 1, depending on changes in the ambient environment parameters—initiation temperature control, by the supplementary element 8 affecting thermodynamic circumstances in the ACFES system in favour of the required initiation. The vehicle 1 can be either one-piece, or with openings equipped with the plugs 6. In a preferred embodiment, the ACFES system includes the element 7 allowing the visual indication of the medium 2 presence, such as the bead 7 with a lower value of specific density compared to that of the medium 2 inside the vehicle 1.

Among the most advantageous applications of the ACFES system are those utilizing signals of the sensors 4 and detectors 5 for processing in electronic indication systems or control units. The ACFES system also works as an autonomous system with an independent function without a link to any other control or regulation systems, is used for direct elimination of the causes of temperature increases or for further processing in electronic indication systems or control units.

The ACFES system allows a quick indication of its functionality. It is characterized by resistance to interference induced by electric fields generated by engineering and technological equipment. The induced automatic disconnection of the power supply units, such as the supply of fuel, gas, power, etc., will be permanent; reconnection without removing the cause of the equipment failure must be eliminated. Upon initiation, the ACFES system requires replacement; for the needs of the protected equipment safeguarding it is a one-time system and a manual intervention of a trained person is required for the reconnection of the power supply units.

### Example 1

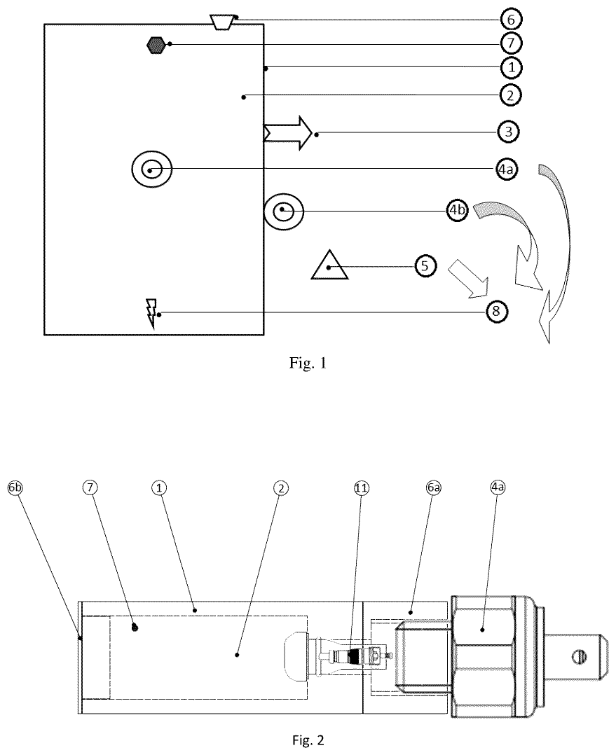

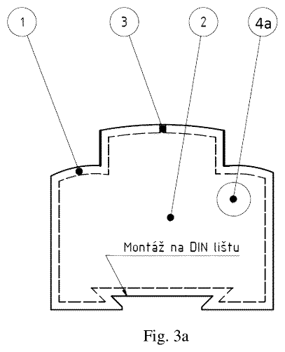

FIG. 2 shows the ACFES system consisting of the vehicle 1 in the shape of a hose that is fitted on one end with the plug 6a and on the other end with the plug 6b, which are made of polymeric material and which are either glued or welded onto the vehicle 1. The plug 6a includes the arranged charging valve 11 for filling the vehicle 1 with the pressurized medium 2. In addition, the plug 6a includes the arranged sensor 4a in the form of a pressure switch for direct elimination of the temperature increase causes; alternatively, its signal can be further processed in the electronic fire alarm and detection systems or control units. The ACFES system may include the indicating item 7 for the visual indication of the medium 2 presence; it refers to an item with a lower value of specific density than specific density of the medium 2; it is arranged in the vehicle 1.

### Example 2

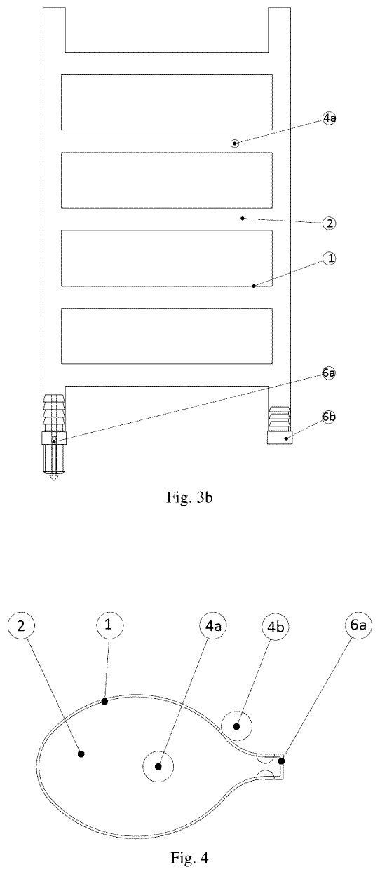

FIG. 3a) shows an example of the ACFES system embodiment for the protection of electric control panels in case that they are positioned on a DIN tray directly in the electric control panel, wherein it consists of the vehicle 1 in the shape of a breaker where the pressurized medium 2 is confined; inside the medium 2 the medium state sensor 4a is arranged, the output signal of which is utilized, depending on the application solution for direct elimination of the causes of increase in temperature or further processed in the form of a signal in electronic indication systems in control units. The vehicle 1 is adjusted to form the nozzle 3 for the release of the medium 2.

### Example 3

FIG. 3b) shows an example of the use of the ACFES system in the shape of a grid for the protection of electric control panels in case that the ACFES system is positioned under the cover case of the electric control panel.

### Example 4

FIG. 4 shows an example of the ACFES system for the safeguarding of breakers and sockets against undesirable thermal effects consisting of the vehicle 1 in the shape of a capsule; inside the vehicle 1 the pressurized medium 2 is confined in which the internal sensor 4a or the external sensor 4b is arranged. The outputs of the sensors can be used for direct elimination of the temperature increase causes or further processed in the form of a signal in the electronic fire alarm and detection systems or control units.

### Example 5

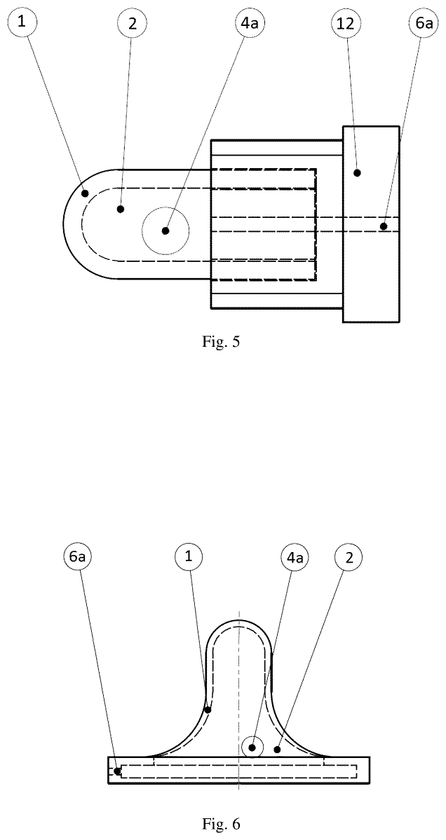

FIG. 5 shows the ACFES system for the protection of the connectors of cable bundles in the shape of a cartridge, and consists of the vehicle 1, in which the pressurized medium 2 is confined and inside the medium 2, the sensor 4a is arranged, the output signal of which is further utilized depending on the application solution, and in addition, the vehicle 1 is fitted with the plug 12 that is adjusted for installation into a connector with cables, and an opening with the plug 6a is arranged inside it. The vehicle 1 is adjusted to form a nozzle for the release of the medium 2.

### Example 6

FIG. 6 shows an example of the ACFES system unit element designed for the protection of battery systems. It consists of the vehicle 1, in which the pressurized medium 2 is confined and inside the medium 2, the sensor 4a is arranged, the output signal of which is further utilized depending on the application solution in the protected equipment control system. The vehicle 1 is adjusted to form a nozzle for the release of the medium 2.

The number of elements, the system size and shape are adjusted according to the size of the protected battery system, wherein individual elements are interconnected in a technological manner or work autonomously.

### Industrial Applicability

The solution of the ACFES system according to the invention can be used for the monitoring and suppression of undesirable thermal effects occurring in engineering and technological equipment where the system utilises, on the one hand, its capacity to cool down the protected equipment, and on the other hand, its capacity to suppress a fire possibly occurring when the critical limits of thermal load of the protected equipment are exceeded or a fire with a different cause. Technological/electronic equipment having smaller as well as larger dimensions, such as sockets, breakers, cables, electrical control panels, connectors and cable bundle joints, battery systems, engines of means of transport and other driving units, regardless of the type of power supply, control systems, central systems of information technological systems, etc. are concerned.

1. (canceled)

2. (canceled)

3. (canceled)

4. (canceled)

5. (canceled)

6. (canceled)

7. (canceled)

8. (canceled)

9. (canceled)

10. An automatic cooling and extinguishing system intended for arrangement in a protected facility, consisting of a medium carrier made of polymer material in shape of regular spatial body, wherein the medium is enclosed, under pressure, inside the carrier and the carrier is adapted to create an opening a nozzle in the carrier in order to release the extinguishing medium due to the initiation temperature, the temperature of the protected facility affecting the medium carrier, whereby the medium is designed as a cooling mixture with extinguishing effects or a just a mixture with extinguishing effects, wherein the system is equipped with passive internal sensor arranged within the carrier and/or with an external sensor, arranged outside the carrier, yet in contact therewith, for monitoring and assessment of thermodynamic state of the medium inside the carrier or of leakage of medium from the carrier and/or the system is equipped with at least one sensor arranged in the area of protected facility yet outside the medium carrier for assessment of thermal processes in the area of protected facility and/or the system is equipped with additional element, arranged outside the protected facility, for detecting the real temperature conditions in the surroundings of the protected area, wherein the system is activated as soon as the temperatures in the protected facility reach 30° C.

11. The system according to claim 10, wherein the system is wirelessly connected to the system of disconnecting the source of power of the protected facility.

12. The system according to claim 10, wherein the system is wirelessly connected to the control system of the protected facility.

13. The system according to claim 10, wherein the system is wirelessly connected to the system of electronic signaling of the protected facility.

14. The system according to claim 10, wherein there is another automatic cooling and extinguishing system with a different initiation temperature arranged within the protected facility.

15. The system according to claim 10, wherein the arrangement of the automatic cooling and extinguishing system is multiplied in case of larger protected facilities, in order to ensure better safety.

16. The system according to claim 10, wherein in case of the medium carrier of regular shape with one or more openings, the openings are covered with terminations made of polymer material and enclosing the medium within the carrier, or with glue or a weld.

17. The system according to claim 10, wherein at least one of the terminations of the carrier is designed with an internal opening for installation of a passive sensor.

18. The system according to claim 10, wherein the minimal length of the hose is 10 mm or more and the internal diameter 3 mm or more.
